(19) United States
(12) Patent Application Publication
(10) Pub. No.: US 2007/0211909 A1
(43) Pub. Date: Sep. 13, 2007

(54) Echo cancellation method in wireless headset communication system

(75) Inventor: An Yu Yen, Taipei (TW)

Correspondence Address: BIRCH STEWART KOLASCH & BIRCH, PO BOX 747, FALLS CHURCH, VA, 22040-0747, US

(73) Assignee: Microlink Communications Inc.

(21) Appl. No.: 11/373,243

(22) Filed: Mar. 13, 2006

(51) Int. Cl. H04B 15/00

(52) U.S. Cl. 381/94.1

(57) ABSTRACT

An echo cancellation method in a wireless headset communication system includes the steps: (1) providing at least one delayer and at least one amplifier for respectively performing a specific phase modulation and a specific amplitude adjustment on at least one branch signal of a receiving signal received from a far-end user, thereby generating at least one pseudo echo signal having identical phase and amplitude with those of at least one actual echo signal; (2) performing at least one signal-mixture process on the pseudo echo signal and a sending signal in which the actual echo signal is contained to subtract the pseudo echo signal from the sending signal, thereby counteracting the actual echo signal. The present invention can provide a better echo cancellation effect, and simultaneously has an advantage in the easiness for bring into practice and low practice cost.

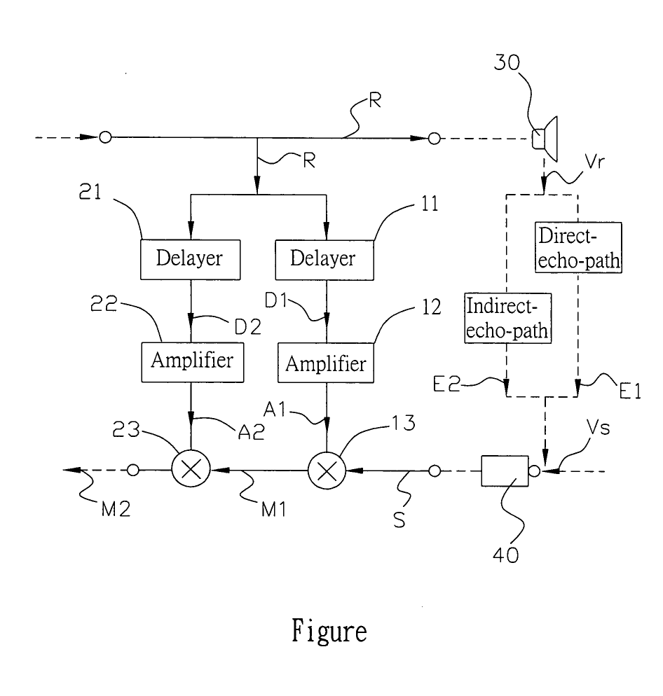

### BACKGROUND OF THE INVENTION

1. Field of the Invention

The present invention relates to an echo cancellation method, and more particularly, to an echo cancellation method in wireless headset communication system.

2. The Related Art

Now, wireless headsets have become the most popular products in electronic communication field because there is no need of a signal wire between the wireless headset and a matching mobile phone. However, most existing wireless headsets, such as bluetooth headsets, have a small size and a consequent short distance between the speaker and the microphone of the bluetooth headset. Therefore, after the speaker of the near-end bluetooth headset broadcasts a receiving voice received from a far-end user out, the receiving voice may be easily transmitted into the microphone of the bluetooth headset, thereby causing actual echoes. The actual echoes are converted to actual echo signals by the microphone, and the actual echo signals are further sent to the far-end user, which results in that the far-end user hears the words said by himself/herself.

It is known that, in a wireless headset communication system, the receiving voice broadcasted out by the speaker of the wireless headset may be transmitted into the microphone of the wireless headset via countless echo paths in theory, so there are countless actual echoes generated between the speaker and the microphone. However, there are only several echoes can be obviously felt by the far-end user in practice. For example, there are two main actual echoes in a bluetooth headset communication system. The two echoes are generated due to two echo paths between the speaker and the microphone, which includes: a direct-echo-path outside the headset housing, and an indirect-echo-path inside the headset housing. Commonly, the two main actual echoes mentioned above are respectively designated as actual short-echo and actual long-echo. After transmitted into the microphone of the bluetooth headset, the actual short-echo and the actual long-echo are converted to an actual short-echo signal and an actual long-echo signal by the microphone of the bluetooth headset. The actual short-echo signal and the actual long-echo signal are further contained in a sending signal according to a sending voice of the near-end bluetooth headset user.

The echoes generated between the speaker and the microphone are conspicuous in the wireless headset communication system, which will interfere the normal communication. Therefore, echo cancellation techniques have been provided for improving the communication quality of the wireless headsets.

The echo cancellation can be achieved by special mechanical design for the wireless headset. The mechanical design is based on the physico-transmission characteristics of the acoustic wave, and the mechanical design includes several aspects as followings: finding the best distance between the speaker and the microphone, defining the best relative location of the speaker and the microphone, structuring the best inner structure of the wireless headset, selecting the best soundproof material and so on. All these aspects have a common objective that is to make the receiving voices broadcasted out by the speaker only be transmitted into the ear of the near-end headset user and the microphone only receive the sending voice of the near-end headset user. However, without a large producing cost, it is difficult to achieve a better echo canceling effect because the high precision demand of the elements of the wireless headset is very difficult to control in producing.

The echo cancellation of the wireless headset can also be achieved by special electrical design. In this manner, the shape and the structure of the wireless headset can be formed firstly, and then an according echo cancellation electrical circuit is provided for canceling the echoes. For example, in the bluetooth headset, a DSP (Digital Signal Process) function is usually integrated within the bluetooth core so as to achieve the echo cancellation function. The bluetooth core integrated DSP function therein can achieve a satisfactory echo cancellation effect. However, this bluetooth core has a considerable cost.

### SUMMARY OF THE INVENTION

Accordingly, an object of the present invention is to provide an echo cancellation method in wireless headset communication system for canceling actual echo signals generated between a speaker and a microphone of the wireless headset with low cost.

To achieve the above object, an echo cancellation method in wireless headset communication system is provided for canceling actual echo signals generated between a speaker and a microphone of the wireless headset, comprising the following steps: (1) providing at least one delayer and at least one amplifier for respectively performing a specific phase modulation and a specific amplitude adjustment on at least one branch signal of a receiving signal received from a far-end user, thereby generating at least one pseudo echo signal having identical phase and amplitude with those of at least one actual echo signal; (2) performing at least one signal-mixture process on the pseudo echo signal and a sending signal in which the actual echo signal is contained to subtract the pseudo echo signal from the sending signal, thereby counteracting the actual echo signal.

The echo cancellation method according to the present invention can directionally cancel the main echoes generated between the speaker and the microphone of the wireless headset, so the echo cancellation method can provide a better echo cancellation effect and simultaneously has an advantage in the easiness for bring into practice and low practice cost.

These and other features, objects and advantages of the present invention will be more fully apparent from the following detailed description set forth below when taken in conjunction with the accompanying drawing.

### BRIEF DESCRIPTION OF THE DRAWING

The FIGURE is a block diagram showing an echo cancellation electrical circuit according to the echo cancellation method of the present invention.

### DETAILED DESCRIPTION OF THE PREFERRED EMBODIMENT

For showing the echo cancellation method according to the present invention in detail, an embodiment is provided in which the method for canceling the actual short-echo and the actual long-echo in a bluetooth headset communication system is described.

The present embodiment provides an electrical circuit for respectively imitating the transmission characteristics of the actual short-echo and the actual long-echo, so as to respectively generate a pseudo short-echo signal and a pseudo long-echo signal. The pseudo short-echo signal and the pseudo long-echo signal are further respectively used for counteracting the actual short-echo signal and the actual long-echo signal.

With reference to the FIGURE, an electrical circuit for practicing the echo cancellation method according to the present invention is illustrated. The electrical circuit includes delayers 11, 21, amplifiers 12, 22, and multipliers 13, 23. The input terminals of the delayers 11 and 21 respectively connect with the input terminal of a speaker 30 of the bluetooth headset. The input terminal of the amplifier 12 connects with the output terminal of the delayer 11, and the input terminal of the amplifier 22 connects with the output terminal of the delayer 21. The input terminal of the multiplier 13 connects with the output terminal of the amplifier 12, and the input terminal of the multiplier 23 connects with the output terminal of the amplifier 22.

With reference to the FIGURE again, the processes of the echo cancellation will be described hereinafter. In one aspect, when a receiving signal R received from a far-end user is converted to a receiving voice Vr and broadcasted out by the speaker 30 of the bluetooth headset, the main part of the receiving voice Vr is transmitted into the ear of the near-end headset user and the other part of the receiving voice Vr is transmitted into the microphone 40 of the bluetooth headset. The part that is transmitted into the microphone via a direct-echo-path generates an actual short-echo E1 (shown in broken line in the FIGURE), and the part that is transmitted into the microphone via an indirect-echo-path generates an actual long-echo E2 (shown in broken line in the FIGURE). The actual short-echo E1 and the actual long-echo E2 are further converted to an actual short-echo signal and an actual long-echo signal by the microphone 40. The actual short-echo signal and the actual long-echo signal are contained in a sending signal S according to a sending voice Vs of the near-end bluetooth headset user.

In another aspect, one branch signal of the receiving signal R is fed into the delayer 11 for performing a specific phase modulation by setting the delay time of the delayer 11. The delay time is matched with the time cost for generating the actual short-echo signal so as to ensure a delay signal D1 output by the delayer 11 has identical phase with the phase of the actual short-echo signal. The delay signal D1 is further fed into the amplifier 12 for performing a specific amplitude adjustment. The amplifying parameter of the amplifier 12 is matched with the amplitude of the actual short-echo signal so as to ensure a pseudo short-echo signal A1 output by the amplifier 12 has identical amplitude with the amplitude of the actual short-echo signal. Similarly, another branch signal of the receiving signal R sequentially passes through the delayer 21 and the amplifier 22 for sequentially performing another specific phase modulation and another specific amplitude adjustment so as to sequentially generate a delay signal D2 and a pseudo long-echo signal A2. The pseudo long-echo signal A2 has identical phase and amplitude with those of the actual long-echo signal.

Thereafter, the pseudo short-echo signal A1 and the sending signal S are simultaneously fed into the multiplier 13, and the multiplier 13 performs a signal-mixture process on the pseudo short-echo signal A1 and the sending signal S in which the actual short-echo signal is contained. In the signal-mixture process, the pseudo short-echo signal A1 is subtracted from the sending signal S, thereby counteracting the actual short-echo signal contained in the sending signal S. The multiplier 13 outputs a short-echo cancelled signal M1, and the short-echo cancelled signal M1 and the pseudo long-echo signal A2 are simultaneously fed into the multiplier 23 where the pseudo long-echo signal A2 counteracts the actual long-echo signal still contained in the short-echo cancelled signal M1. The multiplier 23 outputs a long-echo cancelled signal M2 in which the actual short-echo signal and the actual long-echo signal are not contained.

The embodiment mentioned above is provided only for explaining the echo cancellation method according to present invention. The echo cancellation method according to the present invention should not be limited in bluetooth headsets and the short-echo and the long-echo of the bluetooth headsets, so additional circuits can be provided for canceling additional echoes besides the short-echo and the long-echo. It will be appreciated that, alternatively, the embodiment above can be modified to swap the positions of the delayer and the amplifier each other. Furthermore, the multipliers in the embodiment can be substituted by subtracters. All those modifications can be achieved by simple circuit modification and provide the similar echo canceling effect to the above embodiment.

So the echo cancellation method in wireless headset communication system according to the present invention can be summarized as the steps:
(1) providing at least one delayer and at least one amplifier for respectively performing a specific phase modulation and a specific amplitude adjustment on at least one branch signal of a receiving signal received from a far-end user, thereby generating at least one pseudo echo signal having identical phase and amplitude with those of at least one actual echo signal;
(2) performing at least one signal-mixture process on the pseudo echo signal and a sending signal in which the actual echo signal is contained to subtract the pseudo echo signal from the sending signal, thereby counteracting the actual echo signal.

As mentioned above, the echo cancellation method according to the present invention can directionally cancel the main echoes generated between the speaker and the microphone of the wireless headset, so a better echo cancellation effect can be achieved. Furthermore, the phase modulation and the amplitude adjustment can be achieved by simple electronic units, such as delayers, amplifiers, multipliers and the like, so the present invention simultaneously has an advantage in the easiness for bring into practice and a low practice cost.

What is claimed is:

1. An echo cancellation method in wireless headset communication system for canceling actual echo signals generated between a speaker and a microphone of the wireless headset, comprising the following steps:
(1) providing at least one delayer and at least one amplifier for respectively performing a specific phase modulation and a specific amplitude adjustment on at least one branch signal of a receiving signal received from a far-end user, thereby generating at least one pseudo echo signal having identical phase and amplitude with those of at least one actual echo signal;
(2) performing at least one signal-mixture process on the pseudo echo signal and a sending signal in which the actual echo signal is contained to subtract the pseudo echo signal from the sending signal, thereby counteracting the actual echo signal.

2. The echo cancellation method as claimed in claim 1, wherein the wireless headset is a bluetooth headset in which the actual echo signals include an actual short-echo signal and an actual long-echo signal.

3. The echo cancellation method as claimed in claim 2, wherein one of the delayer and one of the amplifier are set to generate a pseudo short-echo signal to counteract the actual short-echo signal.

4. The echo cancellation method as claimed in claim 2, wherein one of the delayer and one of the amplifier are set to generate a pseudo long-echo signal to counteract the actual long-echo signal.

5. The echo cancellation method as claimed in claim 1, wherein the order of the phase modulation and the amplitude adjustment for generating the pseudo echo signal is: the phase modulation first and the amplitude adjustment next.

6. The echo cancellation method as claimed in claim 1, wherein the order of the phase modulation and the amplitude adjustment for generating the pseudo echo signal is: the amplitude adjustment first and the phase modulation next.

7. The echo cancellation method as claimed in claim 1, wherein the signal-mixture process is performed by a multiplier.

8. The echo cancellation method as claimed in claim 1, wherein the signal-mixture process is performed by a subtracter.
